(19) United States
(12) Patent Application Publication
(10) Pub. No.: US 2009/0162073 A1
(43) Pub. Date: Jun. 25, 2009

(54) OPTICAL MODULE

(75) Inventors: Jun Ojima, Kawasaki (JP); Takashi Takashima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/338,256

(22) Filed: Dec. 18, 2008

(30) Foreign Application Priority Data
Dec. 20, 2007 (JP) 2007-328141

(51) Int. Cl. H04B 10/02; G02B 6/255

(52) U.S. Cl. 398/139; 385/96

(57) ABSTRACT

An optical module includes a fusion splicing optical fiber and a ferrule. The fusion splicing optical fiber includes a first optical fiber including optical fiber ends and a first optical fiber core, a second optical fiber including optical fiber ends and a second optical fiber core, and a fused portion splicing the first optical fiber and the second optical fiber spliced between the optical fiber ends. The ferrule includes a first port, a second port, a third port, a first end surface arranged the first port and the second port, a second end surface arranged the third port, and a ferrule housing the fused portion and the first optical fiber ends and the second optical fiber ends.

### CROSS-REFERENCE TO RELATED APPLICATION

This application is based upon and claims the benefit of priority of the prior Japanese Patent Application No. 2007-328141, filed on Dec. 20, 2007, the entire contents of which are incorporated herein by reference.

### FIELD

An aspect of the present invention relates to an optical module.

### BACKGROUND

In recent years, as an optical access system, a PON (passive optical network) system providing an FTTH (fiber to the home) service at high speed and at a low cost has been put into practical use. The PON system can build an economical network because the PON system is a system which branches an optical signal into a plurality of signals, using an optical splitter without photoelectric conversion, and in which a single core optical fiber is shared among a plurality of users.

FIG. 6 and FIG. 7 are diagrams illustrating an outline of the PON system. FIG. 6 illustrates how a downstream signal from a station to subscribers is transferred. FIG. 7 illustrates how an upstream signal from the subscribers to the station is transferred. The PON system 30 is formed by an OLT (optical line terminal) 31 installed in the station, ONUs (optical network unit) 32-1 to 32-3 installed in-house, and an optical splitter 33 branching an optical fiber. Here, terminals 4-1 to 4-3 such as personal computers are connected to the respective ONUs 32-1 to 32-3.

The optical splitter 33 that multiplexes/demultiplexes optical signals is provided between the OLT 31 and the ONUs 32-1 to 32-3, and optical communications are performed between one OLT 31 and a plurality of the ONUs 32-1 to 32-3 (although the figure shows an example in which an optical signal is branched into 3 signals by the optical splitter 33, the maximum number of branches in the current system is typically 32).

The ONUs 32-1 to 32-3 converts an optical signal transmitted by the OLT 31 into an electric signal. The ONUs 32-1 to 32-3 also converts electric signals transmitted by the terminals 4-1 to 4-3 into optical signals, and transmits them to the OLT 31.

When the downstream (from OLT to ONU) signal in FIG. 6 is transferred, the same signal is transferred from the OLT 31 to the ONUs 32-1 to 32-3 by branching by the optical splitter 33 (wavelength of the downstream signal is 1.55 μm). Therefore, each ONUs receives whole data including other ONUs address DATA. Each ONUs extracts address data of itself and deletes the other ONUs address DATA.

When the upstream (from ONU to OLT) signal in FIG. 7 is transferred, optical signals from the plurality of ONUs 32-1 to 32-3 are multiplexed by the optical splitter 33 (wavelength of the upstream signal is 1.3 ∥m). Therefore, in the ONUs 32-1 to 32-3, multiplexing control is performed in consideration of transmission timing and transmission amount.

FIG. 8 is a diagram illustrating a structure of an optical transceiver used in the OLT 31 and the ONUs 32-1 to 32-3. The optical transceiver 50 includes components: optical transmitter/receiver module 5 that connects with an optical fiber f, an LD (laser diode) drive circuit 50-1, and a main amplifier 50-2.

The LD drive circuit 50-1 and the main amplifier 50-2 are mounted on a printed circuit board 50a, and the transmitter/receiver module 5 is soldered to the printed circuit board 50a at its lead terminal portion. These components are put in a case 50b. Here, the transmitter/receiver module 5 is an optical component having a transmission function and a reception function for an optical signal.

As a structure of a conventional optical module, an optical module has been proposed in which, after three optical fibers have been fused at a center portion, a desired demultiplexing function is given by adjusting the aspect ratio and the coupling ratio of the fused portion (refer to Japanese Laid-open Patent Publication No. 04-359205, paragraphs [0014] to [0022] and FIG. 1).

FIG. 9 is a diagram showing a structure of the optical transmitter/receiver module 5. The conventional transmitter/receiver module 5 includes a LD package 51, a PD (photo diode) package 52, and an optical fiber with WDM (wavelength division multiplex) coupler 53.

The LD package 51 includes a cap with sapphire window 51a, an LD element 51b, a monitor PD element 51c, and a package with lens 51d. The cap with sapphire window 51a is a cap having a sapphire window 51a-1 formed of a sapphire material having a high refractive index and a low dispersion. This cap is put on the LD element 51b and the monitor PD element 51c that have been mounted/wired, with the inside of the LD package 51 being sealed in a nitrogen atmosphere.

The package with lens 51d is a package equipped with a lens 51b-1 for condensing transmission light emitted by the LD element 51b, and is installed so as to cover the cap with sapphire window 51a.

The PD package 52 includes a package with lens 52a, a reception PD element 52b, and a preamplifier 52c. The package with lens 52a is a package equipped with a lens 52a-1 for condensing reception light. In this package, the reception PD element 52b and the preamplifier 52c are mounted/wired, and the inside of the PD package 52 is sealed in a nitrogen atmosphere.

The optical fiber with WDM coupler 53 includes an optical fiber f, a metal ferrule 53a, a sleeve 53b, and a WDM coupler 53c. The optical fiber f is fixed to the metal ferrule 53a, which is inserted into the sleeve 53b and fixed thereto. Here, in the metal ferrule 53a, the WDM coupler 53c is fixed to the position of the front end of the optical fiber f.

When an optical signal is transmitted, the LD drive circuit 50-1 illustrated in FIG. 8 drives the LD element 51b in the transmitter/receiver module 5 through a lead terminal 51-1. The optical signal that has exited from the LD element 51b and past through the sapphire window 51a-1 is condensed by the lens 51b-1. Then, the optical signal passes through the WDM coupler 53c, and after having entered the optical fiber f, it is outputted.

The monitor PD element 51c receives back light from the LD element 51b and after having converted it into an electric signal, transmits it to the LD drive circuit 50-1 through the lead terminal 51-1. The LD drive circuit 50-1 achieves the stabilization of output by driving the LD element 51b so that this electric signal is kept at a given level.

On the other hand, when an optical signal is received, an optical signal inputted through the optical fiber f is branched by the WDM coupler 53c downward by 90°, and enters the reception PD element 52b via the lens 52a-1. The reception PD element 52b generates an electric signal by a photoelectric conversion, and the preamplifier 52c amplifies the electric signal.

The signal amplified by the preamplifier 52c is transmitted to the main amplifier 50-2 shown in FIG. 8 through a lead terminal 52-1, and after having been further amplified by the main amplifier 50-2, it is transmitted to a processing portion located at a subsequent stage. As described above, since the conventional transmitter/receiver module 5 is constructed by collecting individual components: the LD package 51, the PD package 52, and the optical fiber with WDM coupler 53, there has occurred a problem that it is high in cost and large in mounting scale.

Furthermore, because the transmitter/receiver module 5 is configured to branch at the WDM coupler 53c by 90°, it constitutes a component having a T-type configuration, and therefore, a wide space is required when it is mounted on the optical transceiver 50. This has raised a problem of hindering the manufacturing of a downsized optical transceiver 50.

### SUMMARY

According to an aspect of the embodiment, an optical module includes a fusion splicing optical fiber and a ferrule. The fusion splicing optical fiber includes a first optical fiber including optical fiber ends and a first optical fiber core, a second optical fiber including optical fiber ends and a second optical fiber core, and a fused portion splicing the first optical fiber and the second optical fiber spliced between the optical fiber ends The ferrule includes a first port arranged one of ends of the first optical fiber, a second port arranged one of ends of the second optical fiber, a third port arranged an another one of ends of the first optical fiber, a first end surface being arranged the first port and the second port, a second end surface being arranged the third port, and a ferrule housing the fused portion and the first optical fiber ends and the second optical fiber ends.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram of an optical module.

FIG. 2 is a diagram illustrating an aspect ratio.

FIG. 3 is a diagram illustrating a structure of an optical transmitter/receiver module.

FIG. 4 is a diagram illustrating arrangement relationships between optical fibers, a lens, and optical semiconductor devices.

FIG. 5 is a diagram illustrating surroundings of an optical path of an outgoing beam emitted from a port.

FIG. 6 is a diagram illustrating an outline of a PON system.

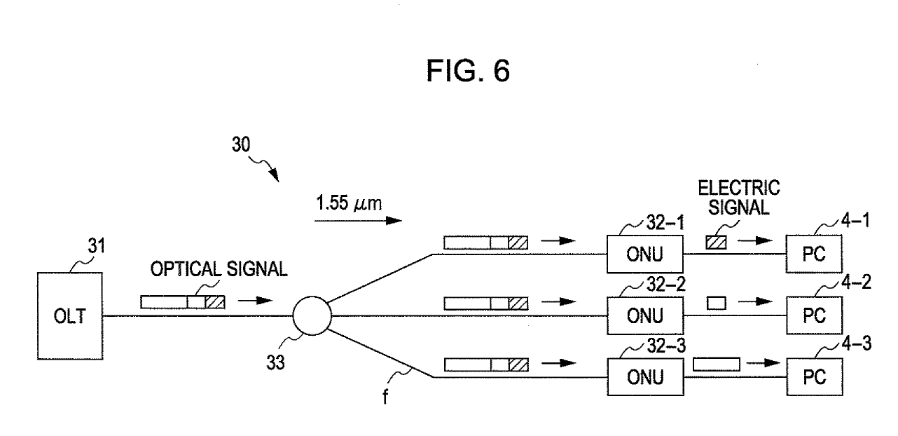

FIG. 7 is a diagram illustrating an outline of a PON system.

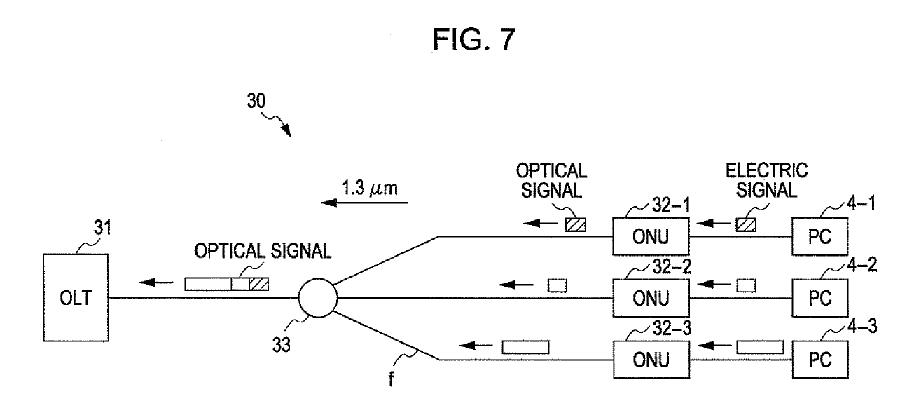

FIG. 8 is a diagram illustrating a structure of an optical transceiver used for an OLT and an ONU.

FIG. 9 is a diagram illustrating a structure of an optical transmitter/receiver module.

### DESCRIPTION OF EMBODIMENTS

One aspect of the present embodiments is to relate to a downsized optical module by reducing the mounting scale. Another One aspect of the present embodiments is to relate to a downsized transmitter/receiver module by reducing the mounting scale.

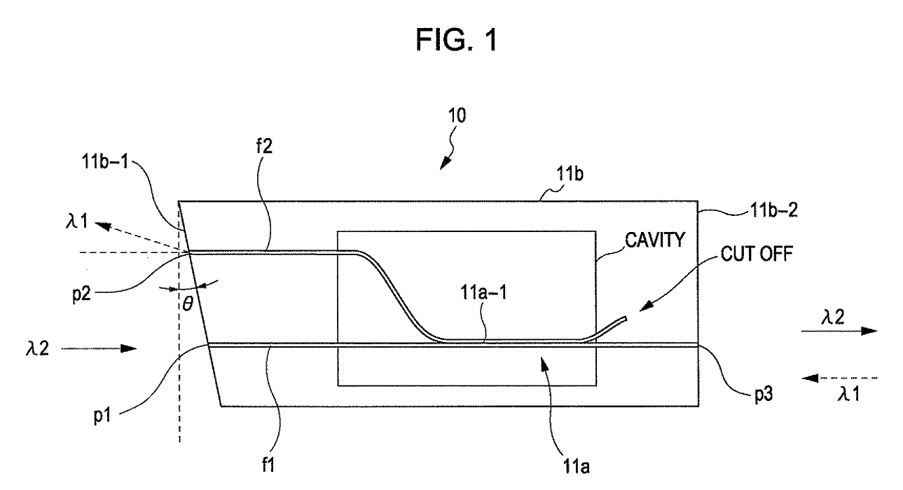

Hereinafter, the embodiments will be described with reference to the drawings. FIG. 1 is a diagram of the optical module. The optical module 10 includes a fusion splicing type optical fiber 11a and a ferrule 11b (metal ferrule).

The fusion splicing type optical fiber 11a is a fusion splicing type optical fiber configured in such a way that a side surface (core side surface) of a second optical fiber (hereinafter, optical fiber f2) is fused to a side surface (core side surface) of a first optical fiber (hereinafter, optical fiber f1). The fusion splicing type optical fiber 11a has a fused portion 11a-1 and optical fiber branching portions, the optical fiber branching portion.

The ferrule 11b is an optical fiber supporting component that accommodates therein the fused portion 11a-1 and its periphery of the fusion splicing type optical fiber 11a. The surroundings of the fused portion 11a-1 of the ferrule 11b is a cavity. The cavity houses the fused portion of the optical fibers f1 and f2.

At one of the optical fiber branching portion, the ferrule 11b has a first end surface 11b-1 and a second end surface 11b-2. At another of optical fiber branching portion the first end surface 11b-1 has an optical fiber end of the optical fiber f1 as a first port p1 and an optical fiber end of the optical fiber f2 as a second port p2. The second end surface 11b-2 has an optical fiber end of the optical fiber f1 as a third port p3. An end portion of the optical fiber f2, to be located on the end face 11b-2 is cut and accommodated within the ferrule 11b.

The first end surface of the ferrule 11b is polished at the inclination angle θ. Therefore, the end surface shape of the port p2 has an inclination angle θ with an axis of the optical fiber f2. That is, if the end face 11b-1 is polished at the inclination angle θ, the end face of the port p2 has also the inclination angle θ (the same goes with the end face of the port p1. The inclination angle θ of the optical fiber f2 allows a signal light outputted from the port p2 of the optical fiber f2 to exit at a predetermined angle.

In the fused portion 11a-1, the fusion splicing type optical fiber 11a has a demultiplexing function, which divides light into wavelengths λ1 and λ2 different from each other. For example, a signal light with a first wavelength (λ1), incident on the port p3 branches at the fused portion 11a-1 of the fusion splicing type optical fiber 11a, and exits from the port p2. Moreover, a signal light incident on the port p1, having a second wavelength (λ2) different from the first wavelength, exits from the port p3.

Next, explanation is made of parameter adjustment when the optical fibers are fused and the fused portion is provided with a demultiplexing function. By adjusting the aspect ratio and the coupling ratio as parameters, the fused portion is given a desired demultiplexing function.

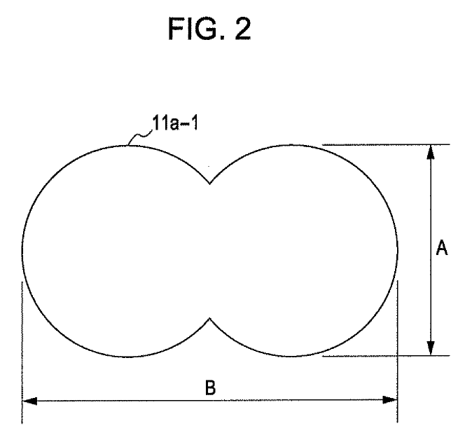

FIG. 2 is a diagram illustrating an aspect ratio. The aspect ratio of the fused portion 11a-1 is a value of the longer length B on the cross section of fused portion 11a-1 divided by a value of the shorter length A thereon, i.e., B/A. By adjusting the aspect ratio, a difference between λ1 and λ2 can be determined.

On the other hand, the coupling ratio is defined as follows: for example, when light is inputted from the port p3, the coupling ratio is the ratio of the intensity of this input light relative to the intensity of output light outputted from the ports p1 and p2. The coupling ratio varies depending on the length of the fused portion 11a-1, i.e., coupling length.

Here, supposing, for example, light with a wavelength λ1 of 1.55 μm is outputted from the port p3 to the port p2, and light with a wavelength λ2 of 1.3 μm is outputted from the port p3 to the port p1, then, the aspect ratio of the fused portion 11a-i is adjusted so as to be 0.25 μm (=1.55−1.3), and the length of the fused portion 11a-1, i.e., coupling length is adjusted so that the wavelength λ1 becomes 1.55 μm.

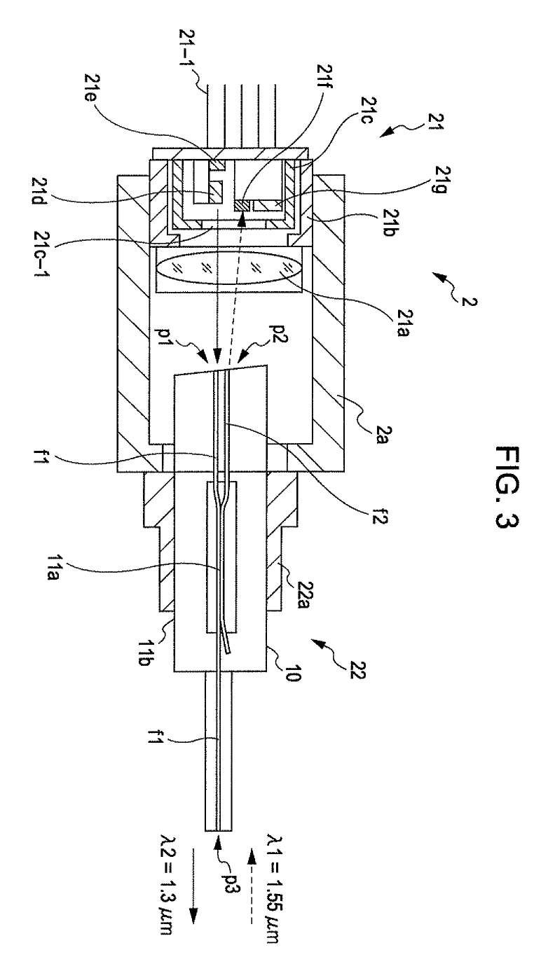

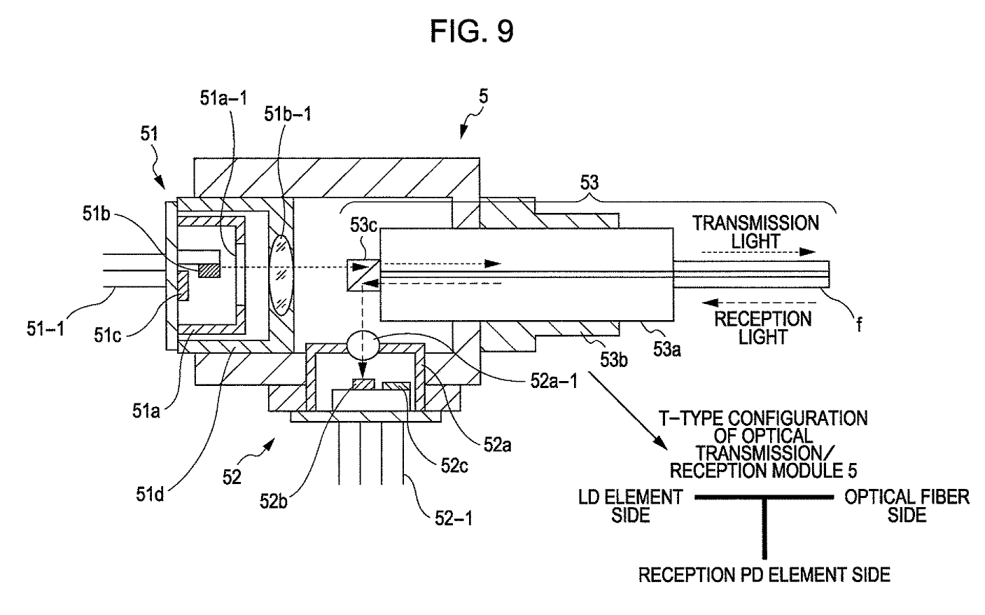

Next, explanation is made of the case in which the optical module 10 is applied to the ONU of the PON system. FIG. 3 is a diagram illustrating a structure of an optical transmitter/receiver module. The transmitter/receiver module 2 includes an optical semiconductor package portion 21 (corresponding to an optical element portion) and an optical fiber assembly portion 22 including the optical module 10. When the optical module 10 is applied to the PON system, the transmitter/receiver module 2 in FIG. 3 is installed instead of the transmitter/receiver module 5 shown in FIG. 9.

The optical semiconductor package portion 21 includes a lens 21a, a holder 21b, a cap with sapphire window 21c, an LD element 21d (corresponding to a light-emitting element), a monitor PD element 21e, reception PD element 21f (corresponding to a light-receiving element or photo detector), and a preamplifier 21g.

The cap with sapphire window 21c is a cap having a sapphire window 21c-1 formed of a sapphire material having a high refractive index and a low dispersion. The cap with sapphire window 21c is put on the LD element 21d, the monitor PD element 21e, the reception PD element 21f, and the preamplifier 21g that are mounted/wired, with the inside of the optical semiconductor package portion 21 being sealed in a nitrogen atmosphere.

The holder 21b is installed so as to cover the side surfaces of the cap with sapphire window 21c, and the lens 21a is fixed in the vicinity of the sapphire window 21c-1. Since optical semiconductors such as the LD element 21d and the reception PD element 21f can be arranged closely to each other as shown in the figure, their integration is feasible, thereby achieving a size reduction of the entire module.

On the other hand, the optical fiber assembly portion 22 includes the optical module 10 shown in FIG. 1 and a sleeve 22a. The optical module 10 is inserted into the sleeve 22a and fixed thereto. Since the structure of the optical module 10 has been explained above, description thereof is omitted.

Here, mounting methods for components are simply described. Semiconductor elements such as the LD element 21d, the monitor PD element 21e, the reception PD element 21f, and the preamplifier 21g are mounted on a package of the optical semiconductor package portion 21 using solder or a conductive adhesive, and wiring portions of these semiconductor elements and the package are connected by wire bonding.

Then, the cap with sapphire window 21c is put on the above-described components so as to seal the inside of the optical semiconductor package portion 21 in the nitrogen atmosphere, and fixed to the package by welding. Thereafter, the holder 21b is fixed to the package of the optical semiconductor package portion 21 by laser welding.

Furthermore, an adjustment is performed so as to align center positions of the LD element 21d and the lens 21a with each other by image recognition or the like. Then, the lens 21a is fixed onto the package of the optical semiconductor package portion 21 by laser welding, and after the optical semiconductor package portion 21 has been mounted on a main body 2a, the holder 21b is fixed to the main body 2a by laser welding. Then, after optical axis alignment between the optical fiber assembly portion 22 and the optical semiconductor package portion 21 has been performed, the optical fiber assembly portion 22 is fixed onto the package of the optical semiconductor package portion 21 by laser welding.

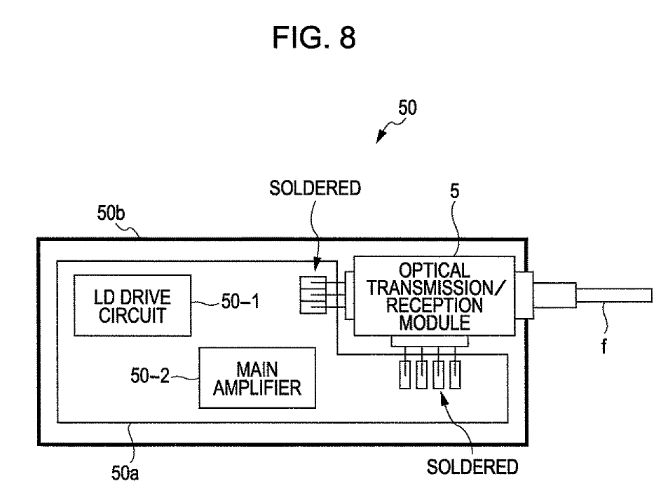

Next, operations are explained. When signal light with a wavelength of 1.3 μm is transmitted to the OLT, the LD drive circuit 50-1 shown in FIG. 8 drives the LD element 21d in the transmitter/receiver module 2 through a lead terminal 21-1. The signal light with a wavelength of 1.3 μm having exited from the LD element 21d and past through the sapphire window 21c-1 is condensed by the lens 21a. Then, the signal light proceeds along a straightforward direction, and after having entered the optical fiber f1, it is outputted.

The monitor PD element 21e receives back light from the LD element 21d, converts the light into an electric signal, and transmits the electric signal to the LD drive circuit 50-1 through the lead terminal 21-1. The LD drive circuit 50-1 achieves the stabilization of output by driving, through feedback control, the LD element 51b so that this electric signal is kept at a given level or constant level.

On the other hand, when the transmitter/receiver module 2 receive a signal light with a wavelength of 1.55 μm transmitted from the OLT, the fused portion 11a-1 of the optical fiber assembly portion 22 branches the inputted signal light from the optical fiber f1. The port p2 of the optical fiber assembly portion 22 outputs branched signal light at a definite angle through the optical fiber f2; The output light from the port p2 input into the reception PD element 21f via the lens 21a. The reception PD element 21f receives the signal light with the wavelength of 1.55 μm, and generates an electric signal by a photoelectric conversion. The preamplifier 21g amplifies this electric signal.

The amplified electric signal by the preamplifier 21g is transmitted to the main amplifier 50-2 illustrated in FIG. 8 through the lead terminal 21-1. In addition, the main amplifier 50-2 amplifies the amplified electric signal by the preamplifier 21g. The amplified electric signal by the main amplifier 50-2 is transmitted to the processing portion at a subsequent stage.

Next, description is made of arrangement relationships between the optical fibers, the lens, and the semiconductor elements in the transmitter/receiver module 2. In the description hereinafter, it is assumed that the lens 21a has no aberration (aberration: error resulted from the imperfectness of imaging of an optical system) because the curvature radius of the lens 21a is large.

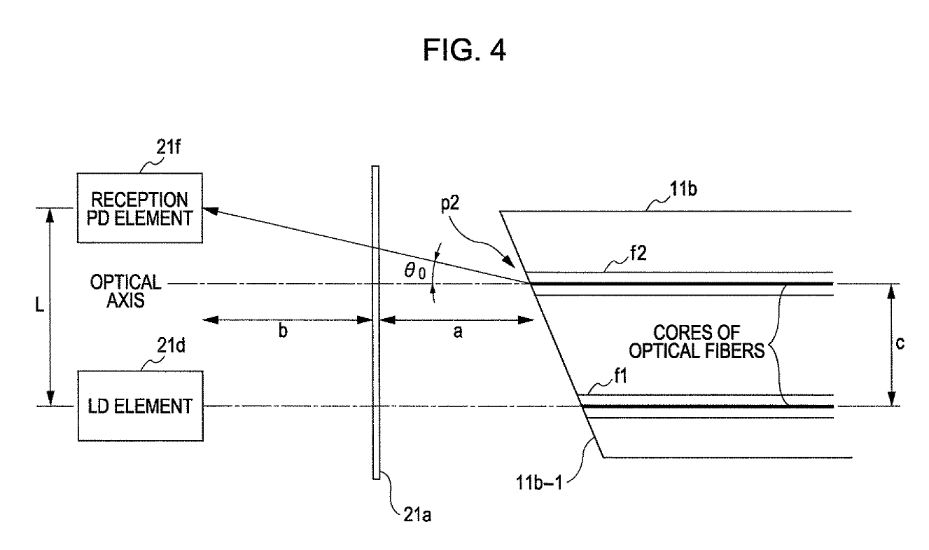

FIG. 4 is a diagram illustrating arrangement relationships between the optical fibers, the lens, and the optical semiconductor devices. In FIG. 4 illustrates arrangement relationships between the ferrule 11b, the lens 21a, the LD element 21d, the reception PD element 21f are illustrated.

When the LD element 21d and reception PD element 21f are to be arranged adjacently to each other as in the figure, a space of vertical direction between the LD element 21d and the reception PD element 21f of the is at least distance L apart from each other, because of sizes of respective components.

When the space is distance L, other portions are defined as below. The distance between the port p2 and the lens 21a is “a”. The distance between the lens 21a and the reception PD element 21f is “b”. The distance between the core of the optical fiber f1 and the core of the optical fiber f2 is “c”. The outgoing angle of outgoing light from the port p2 relative to an optical axis of the optical fiber f2 is θ₀.

Then, these parameters satisfy the following expression (1).

L=(a+b)*tan θ₀+c (1)

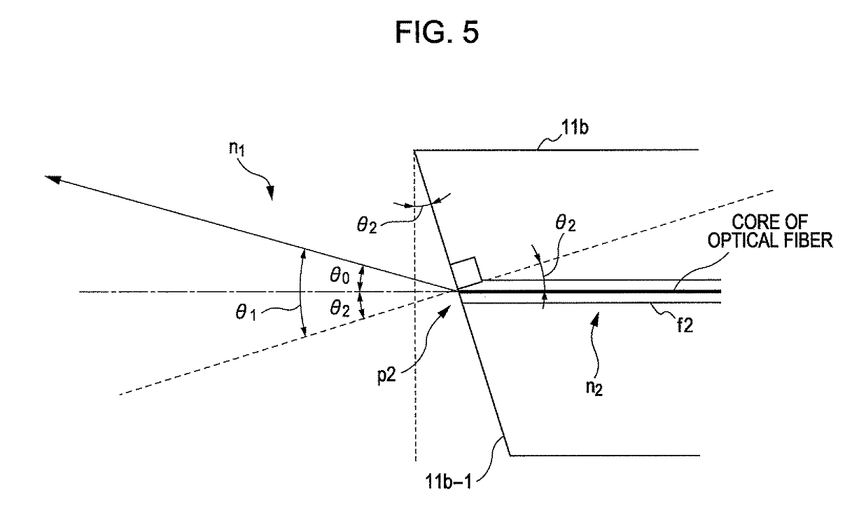

FIG. 5 is a diagram illustrating surroundings of an optical path of outgoing light emitted from the port p2.

Here, the outgoing angle of outgoing light from the port 2 relative to the two-core side end face of the ferrule 11b is represented by θ_{1,} the refractive index of a medium in emission space of the outgoing light is represented by n₁, the refractive index of a medium of the optical fiber f2 is represented by n₂, and the inclination angle of the end face 11b-1 of the ferrule 11b is represented by θ₂.

Then, these parameters satisfy the following expression (2) on the basis of Snell's law.

n₁*sin θ₁=n₂*sin θ₂ (2)

On the other hand, the relationship among θ₀, θ₁ and θ₂ satisfies the following expression (3).

θ₁=θ₀+θ₂ (3)

Here, an inclination angle θ₂ of the end face 11b-1 of the ferrule 11b is set so as to arrange the LD element 21d and the reception PD element 21f in the distance L of at least 0.3 mm. When the inclination angle θ₂ is assumed to be 6°, a distance L is calculated in a manner to be described.

Since the emission space of outgoing light is constituted of air, n₁=1, the refractive index of an outgoing space of output light is n₁=1 because the outgoing space is air. The refractive index of the optical fiber f2 is n2=1.45.

Also, since the inclination angle θ₂ of the end face 11b-1 of the ferrule 11b has been temporarily determined to be 6°, these numerals are substituted into the expression (2).

As a result,

1*sin θ₁=1.45* sin θ₂

Therefore,

$$\begin{matrix}sin {θ}_{1} = 1.45 * sin {θ}_{2} = 1.45 * sin 6 ° \\ = 1.45 * 0.10453 = 0.1516\end{matrix} \qquad ( 2 a )$$

Thus, the equation (2a) gives θ₁=8.72. Then, substituting θ₁=8.72° and θ₂=6° into the expression (3) gives θ₀=8.72°−6°, resulting in θ₀=2.72°.

On the other hand, as specific numerals of other parameters, there are provided the distance “a” between the port p2 and the lens 21a is a=4 mm, the distance “b” between the lens 21a and the reception PD element 21f, is b=1.4 mm, and the distance “c” between the core of the optical fiber f1 and that of the optical fiber f2 is, c=0.125 mm.

Substitution of these values into the expression (1) gives L=(4+1.4)*tan 2.72°+0.125 mm, resulting in L=0.382 mm. This value satisfies the requirement for the distance between the LD element 21d and the reception PD element 21f to be 0.3 mm at the minimum. This illustrates that the end face 11b-1 of the ferrule 11b may be polished so that the inclination angle θ₂ becomes 6°.

Accordingly, a polishing angle θ₂, (inclination angle) of the ferrule 11b is determined by the use of the calculation using the above-described expressions (1) to (3). More specifically, L is determined with a value of θ₂ being temporarily fixed because L and θ₂ are variable parameters settable when the module is manufactured.

As described above, the optical module 10 in the transmitter/receiver module 2 include the fusion splicing type optical fiber 11a and the ferrule 11b. The fusion splicing type optical fiber 11a is made by fused the side surface of the optical fiber f1 and the side surface of the optical fiber f1. The ferrule 11b accommodates the fusion splicing type optical fiber 11a, the fusion splicing type optical fiber 11a including the one end portion of the optical fiber f1 as the port p1, the one end portion of the optical fiber f2 as the port p2 and the other end portion of the optical fiber f1 as the port p3. And also, a structure of the optical module 10 in the transmitter/receiver module 2 has the end face 11b-1 having a shape polished at an inclination angle θ in order to provide the end face shape of the port p2 with an inclination angle θ.

With such an arrangement, since a minimum required vertical distance between the light-emitting element and the light-receiving element can be secured and they can be arranged at adjacent positions, integration of the semiconductor elements becomes feasible. Furthermore, since components such as the WDM coupler that have hitherto been existed become unnecessary, cost is cut down, and the reduction in mounting scale and the size-reduction of device are achieved.

Moreover, since the light-emitting element and the light-receiving element can be adjacently arranged with respect to the horizontal direction of the optical fiber, the transmitter/receiver module according to the present invention does not assume a T-type structure unlike the conventional module. Therefore, when the optical transmitter/receiver module is mounted on the optical transceiver, a far small mounting space will suffice compared with the conventional case, thereby allowing the achievement of a downsized optical transceiver.

In the above-described descriptions, the case where the transmitter/receiver module 2 is applied to the PON system has been taken as an example. However, the present invention is not limited to the PON system. The optical module and the transmitter/receiver module according to the present invention are applicable to optical communication systems in a variety of fields.

Therefore, according to the optical module of the embodiments, the mounting scale is reduced, and the downsizing of the device can be achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention,

What is claimed is:

1. An optical module for optical communication, the optical module comprising:
a fusion splicing optical fiber including:
a first optical fiber including optical fiber ends and a first optical fiber core,
a second optical fiber including optical fiber ends and a second optical fiber core, and
a fused portion splicing the first optical fiber and the second optical fiber spliced between the optical fiber ends; and
a ferrule including:
a first port arranged one of ends of the first optical fiber,
a second port arranged one of ends of the second optical fiber,
a third port arranged an another one of ends of the first optical fiber,
a first end surface being arranged the first port and the second port,
a second end surface being arranged the third port, and
a ferrule housing the fused portion and the first optical fiber ends and the second optical fiber ends.

2. The optical module of the claim 1, wherein the fusion splicing optical fiber is a wavelength division multiplexing coupler which has a wavelength characteristic.

3. The optical module of the claim 2, wherein:
the second port for outputting a first wavelength light of the light inputted the third port;
the first port inputted a second wavelength light; and
the third port outputting the light inputted the first port.

4. The optical module of the claim 1, further comprising:
a lens;
a photo detector for detecting light from the second port via the lens; and
a light emitting element for emitting light to the first port via the lens.

5. The optical module of the claim 2,
further comprising:
a lens;
a photo detector for detecting light from the second port via the lens;
a light emitting element for emitting light to the first port via the lens;
a first space arranged between the photo detector and the light emitting device being in distance at least distance L;
a second space arranged between the lens and the first ferrule end, the second space having refractive index n₁;
a distance a being the lens from the second port;
a distance b being the lens from the photo detector; and
a distance c being the first optical fiber core from the second optical fiber core;
wherein:
the first wavelength light has an outputting angle θ₁ relate to the first end face of the ferrule;
the second port outputs a first wavelength light of the light inputted the third port, the first wavelength light having an outputting angle θ₀ relate to an axis of the second optical fiber;
the first port is inputted a second wavelength light;
the third port outputs the light inputted the first port;
the second optical fiber has refractive index n₂;
the first ferrule end has an inclination angle θ₂;
the distance “L” is defined in the first formula;
L=(a+b)*tan θθ₀+c (first formula)
the outputting angle θ₁ is defined in the second formula; and
n₁*sin θ₁=n₂*sin θ2 (second formula)
the inclination angle θ₂ is defined in θ₁=θ₀+θ₂.
